(19) United States
(12) Patent Application Publication
(10) Pub. No.: US 2012/0115371 A1
(43) Pub. Date: May 10, 2012

(54) Connector

(76) Inventors: Wen-Ching Chuang, Taipei (TW); Sheng-Wen Peng, Taipei (TW); Huei-Shun Feng, Taipei (TW)

(21) Appl. No.: 13/292,416

(22) Filed: Nov. 9, 2011

(30) Foreign Application Priority Data
Nov. 9, 2010 (TW) 99221659

(51) Int. Cl. H01R 24/00

(52) U.S. Cl. 439/660

(57) ABSTRACT

A connector having a basic structure of a Slimline SATA connector with terminal sets for transmitting PCIe signals. The connector includes a first plurality of conductive terminals and a first insulating body, as well as second plurality of conductive terminals and a second insulating body. The first insulating body includes a port and a plurality of terminal grooves for receiving the first plurality of conductive terminals. The second insulating body includes a slot, L-shaped tongue members, and a plurality of terminal grooves for engagement with the second plurality of conductive terminals.

### CROSS-REFERENCE TO RELATED APPLICATION

This application claims the benefit under 35 U.S.C. §119(a)-(d) of Taiwan Utility Model Application No. 99221659 filed on Nov. 9, 2010.

### FIELD OF THE INVENTION

The invention relates to a connector, and more particularly, to a connector for providing electrical connection between two electronic components, such as a socket connector and a plug connector.

### BACKGROUND

To enable efficient data transmission, computers and computer peripheral devices are equipped with connectors of different protocols. Connectors of different protocols transmit different signals. As a result, to transmit more than one type of signal, it is necessary to switch between different connectors, thereby bringing inconvenience to users.

Connectors of the Slimline SATA, newly disclosed in the Version 2.6 Standard published by the Serial ATA International Organization (SATA-IO), are aimed at meeting the low-structure requirement of thin notebook computers and thin CD-ROM drives. Connectors of the PCIe Gen 2 protocol are aimed at transmitting high-speed signals. The aforesaid two types of connectors work by different protocols. As a result, it is necessary for users to change when the two types of connectors are used, thereby bringing inconvenience to the users. Furthermore, connectors of the Slimline SATA have specific structures and dimensions. Accordingly, it is imperative to combine the two in order to enhance ease of use and carry out diverse structural improvements.

### SUMMARY

One objective of the invention is to equip a conventional Slimline SATA connector with terminal sets (conductive terminal sets) for transmitting PCIe signals, yet preserve the appearance and basic structure of the conventional Slimline SATA connector, such that the connector meet both the SATA protocol and the PCIe Gen 2 protocol.

Another objective of the invention is to provide a connector that has the appearance and basic structure of a Slimline SATA connector and has a plurality of terminal sets (conductive terminal sets) for transmitting PCIe signals, wherein the plurality of terminal sets (conductive terminal sets) for transmitting PCIe signals comprises high-speed and low-speed signal transmission pins and power signal transmission pins, such that the connector can work in conjunction with other input/output devices of the PCIe Gen. 2 protocol.

Yet another objective of the invention is to provide a socket connector and a plug connector for transmitting SATA signals or PCIe signals, thereby dispensing with the hassles of changing the connectors.

In order to achieve the above and other objectives, inter alia, the invention provides a connector having an appearance and basic structure of a Slimline SATA connector and equipped with a plurality of conductive terminal sets for transmitting PCIe signals, the plurality of terminal sets (conductive terminal sets) for transmitting PCIe signals comprises high-speed and low-speed signal terminal sets and a power signal terminal set, such that the connector is suitable for use with other devices in conformity with the PCIe Gen. 2 protocol.

The connector according to the invention includes a first plurality of conductive terminals and a first insulating body, as well as second plurality of conductive terminals and a second insulating body. The first plurality of conductive terminals includes a first high-speed signal terminal, a first low-speed signal terminal, and a first power signal terminal. The first insulating body includes a port and a plurality of terminal grooves for receiving the first plurality of conductive terminals. The first power signal terminal is positioned together with the low-speed signal terminals, along two opposing sidewalls inside the first insulating body and in two alternate rows. The second plurality of conductive terminals include a second low-speed terminal and a second power signal terminal The second insulating body includes a slot, L-shaped tongue members, and a plurality of terminal grooves for engagement with the second plurality of conductive terminals, wherein the second power signal terminal is positioned together with the second low-speed terminal on two different sides of one the L-shaped tongue members.

### BRIEF DESCRIPTION OF THE DRAWINGS

The above and other objects, features and other advantages of the invention will be more clearly understood from the following detailed description taken in conjunction with the accompanying drawings, in which:

FIG. 1 is an exploded perspective view of a connector according to the invention;

FIG. 2A is an exploded perspective view of a socket connector according to the invention;

FIG. 2B is a perspective view of the socket connector shown in FIG. 2A;

FIG. 3 is a top view of a first conductive terminal set and a second conductive terminal set of the socket connector according to the invention;

FIG. 4 is a side cross-sectional view of the socket connector according to the invention;

FIG. 5A is a schematic plan view of the first conductive terminal set having a inclined portion according to the invention;

FIG. 5B is a schematic plan view of a known conductive terminal;

FIG. 6A is an exploded perspective view of another socket connector according to the invention;

FIG. 6B is an assembled view of the socket connector shown in FIG. 6A;

FIG. 7 is a side cross-sectional view of the socket connector shown in FIG. 6A;

FIG. 8 is a schematic view of a circuit board operating in conjunction with and connected to the first conductive terminal set through a fourth conductive terminal set of the socket connector according to the invention;

FIG. 9A is an exploded perspective view of a plug connector according to the invention;

FIG. 9B is a partial exploded perspective view of the plug connector shown in FIG. 9A;

FIG. 9C is an assembled perspective view of the plug connector shown in FIG. 9A;

FIG. 9D is an assembled perspective view of the plug connector shown in FIG. 9C from a different view angle;

FIG. 10 is an exploded perspective view of a plurality of conductive terminal sets according to the invention;

FIG. 11A is an exploded view of a socket connector and a plug connector connected to each other according to the invention;

FIG. 11B is an assembled view of the socket connector and the plug connector shown in FIG. 11A;

FIG. 12 is a schematic view of a circuit board operating in conjunction with and connected to a fifth conductive terminal set through an eighth conductive terminal set of the plug connector according to the invention; and

FIG. 13 is a collection of schematic diagrams of simulated optimization of the socket connector and the plug connector of the invention.

### DETAILED DESCRIPTION OF THE EMBODIMENT(S)

Although the invention is disclosed below by preferred embodiments and the accompanying drawings, persons skilled in the art can modify the preferred embodiments and still achieve the functions and effects of the invention. Accordingly, the invention is generally disclosed to persons skilled in the art, and the disclosure of the invention is illustrative, rather than restrictive of, the invention.

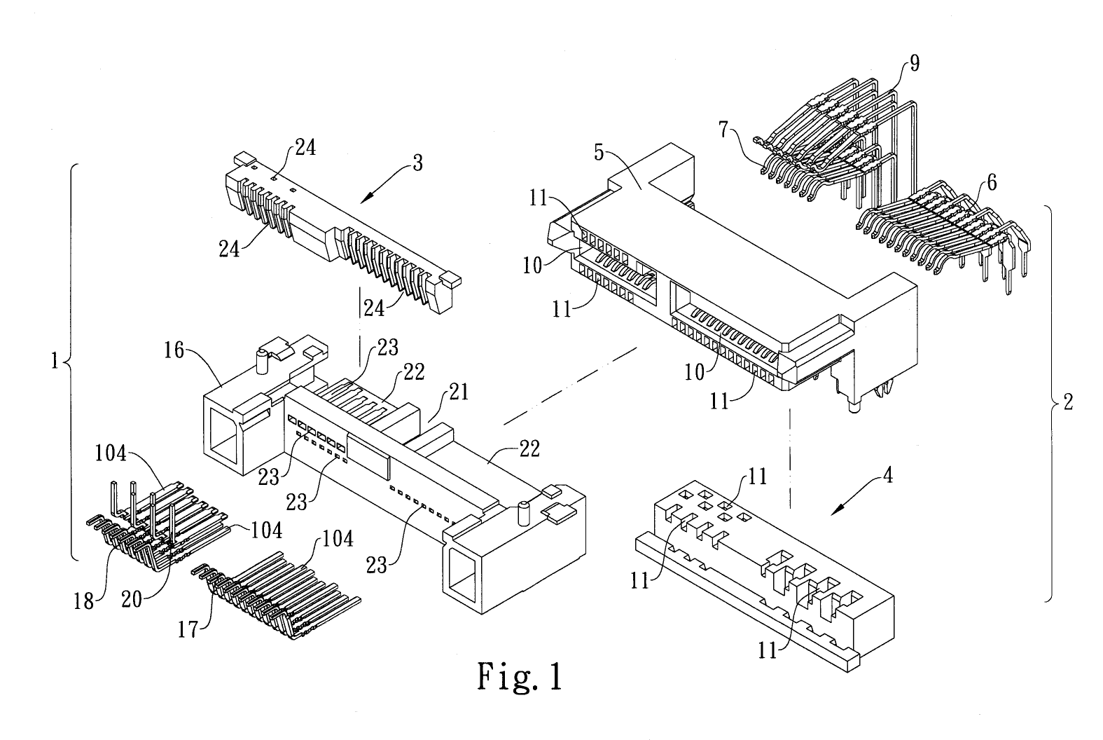

Referring to FIG. 1, there is shown an exploded perspective view of a connector according to the invention. The connector of the invention has the appearance and basic structure of a Slimline SATA connector, and has a plurality of conductive terminal sets for transmitting PCIe signals. The plurality of terminal sets (conductive terminal sets) for transmitting PCIe signals comprises high-speed and low-speed signal terminal sets and a power signal terminal set. Hence, the connector of the invention can work in conjunction with other devices that comply with the PCIe Gen. 2 protocol.

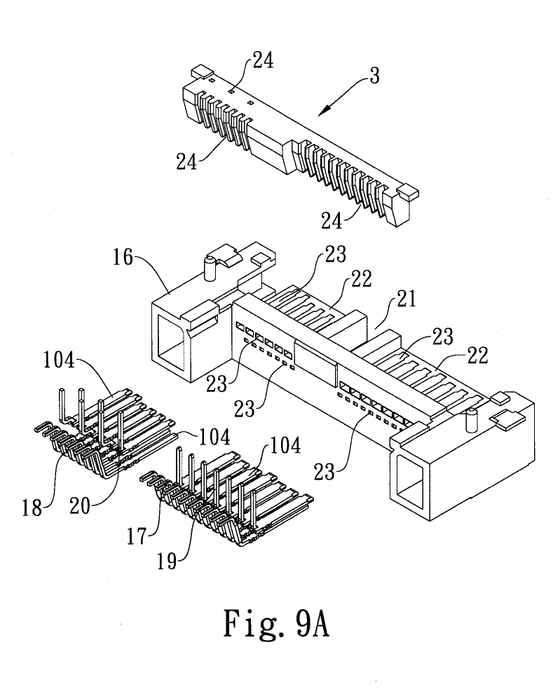

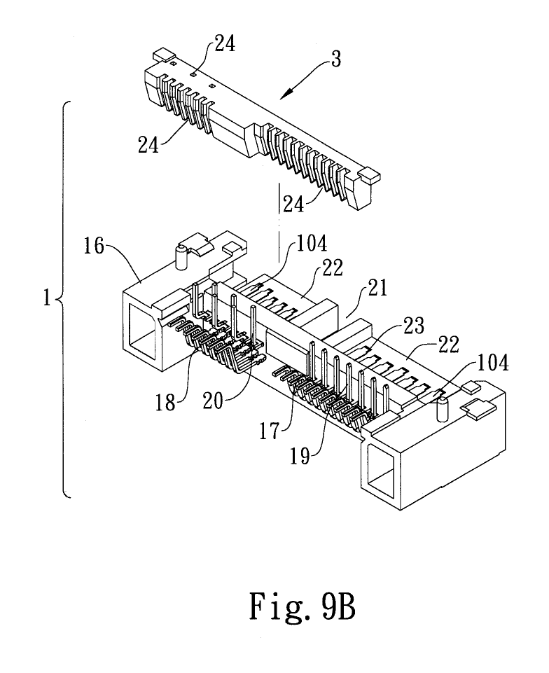

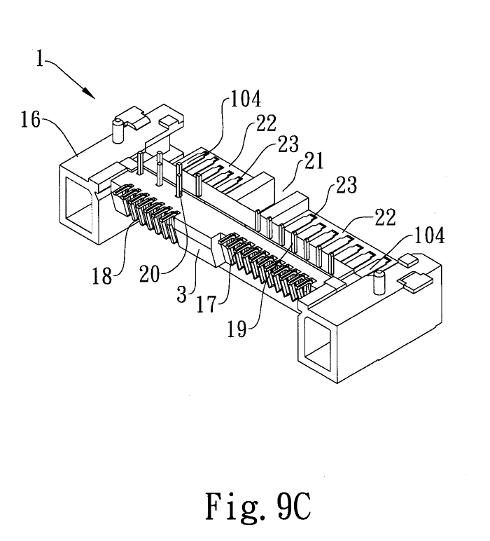

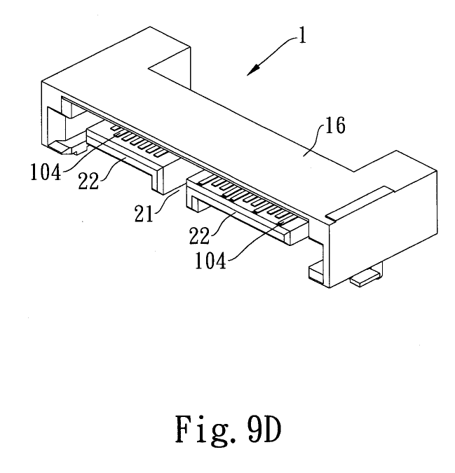

Referring to FIG. 1, in shown embodiment, a plug connector 1 and a socket connector 2 are provided. The plug connector 1 includes an insulating body 16, a plurality of conductive terminal sets for transmitting PCIe signals, and a back cover 3 (see FIG. 9B). The socket connector 2 includes an insulating body 5, a plurality of conductive terminal sets for transmitting PCIe signals, and a back cover 4. In the socket connector 2, the plurality of conductive terminal sets for transmitting PCIe signals are of two types, namely a signal terminal set and a power terminal set. There are two signal terminal sets of the socket connector 2, namely a first conductive terminal set 6 and a second conductive terminal set 7. The power terminal set of the socket connector 2 is a fourth conductive terminal set 9. In the plug connector 1, the plurality of conductive terminal sets for transmitting PCIe signals are of two types, namely a signal terminal set and a power terminal set. There are two signal terminal sets of the plug connector 1, namely a fifth conductive terminal set 17 and a sixth conductive terminal set 18. The power terminal set of the plug connector 1 is an eighth conductive terminal set 20.

In the embodiment shown, the first conductive terminal set 6 and the fifth conductive terminal set 17 are high-speed signal terminal sets, while the second conductive terminal set 7 and the sixth conductive terminal set 18 are low-speed signal terminal sets. The first conductive terminal set 6 and the fifth conductive terminal set 17 each include 11 pins, with a transverse distance of 0.8 mm between the conductive terminals. The second conductive terminal set 7 and the sixth conductive terminal set 18 each include seven pins, with a transverse distance of 0.8 mm between the conductive terminals. The fourth conductive terminal set 9 and the eighth conductive terminal set 20 each include six pins, with a transverse distance of 1 mm between the conductive terminals.

The second conductive terminal set 7 and the fourth conductive terminal set 9 are positioned one above the other. The first conductive terminal set 6 and the second conductive terminal set 7 are arranged side by side and parallel to each other. Likewise, the sixth conductive terminal set 18 and the eighth conductive terminal set 20 are positioned one above the other. The fifth conductive terminal set 17 and the sixth conductive terminal set 18 are arranged side by side and parallel to each other.

The insulating body 5 of the socket connector 2 has two Slimline SATA-style ports 10. The two Slimline SATA-style ports 10 are L-shaped and are arranged side by side. A plurality of terminal grooves 11 corresponding in position to the first conductive terminal set 6, the second conductive terminal set 7, and the fourth conductive terminal set 9 are disposed on the insulating body 5 and the back cover 4. The insulating body 16 of the plug connector 1 has a Slimline SATA-style slot 21, two L-shaped tongue members 22, and a plurality of terminal grooves 23 for engagement with the fifth conductive terminal set 17, the sixth conductive terminal set 18, and the eighth conductive terminal set 20.

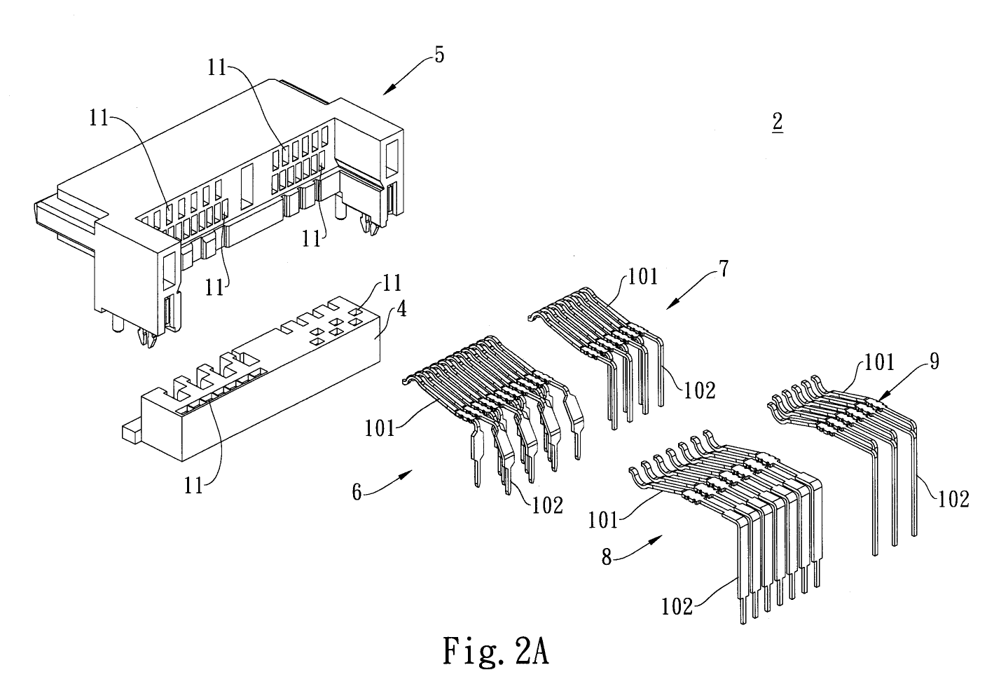

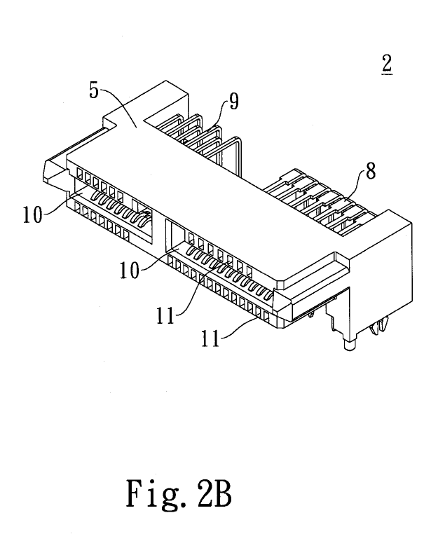

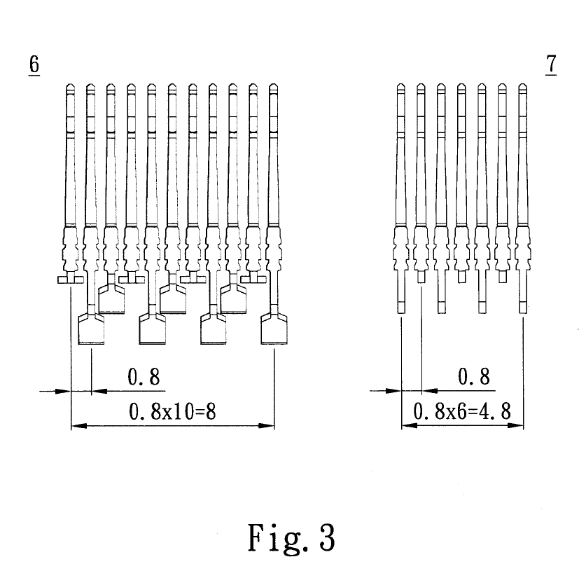

Furthermore, the connector of the invention further includes a plurality of terminal sets (conductive terminal sets) for transmitting SATA signals and the power signal transmission pins for transmitting SATA signals, such that the connector of the invention can work in conjunction with other devices that comply with the SATA protocol. Referring to FIG. 2A, there is shown an exploded perspective view of the socket connector 2 according to the another embodiment of the invention. The socket connector 2 includes an insulating body 5, a plurality of conductive terminal sets, and a back cover 4. The plurality of conductive terminal sets includes signal terminal sets and a power terminal set. The signal terminal sets include the first conductive terminal set 6, the second conductive terminal set 7, and a third conductive terminal set 8. The power terminal set is the fourth conductive terminal set 9.

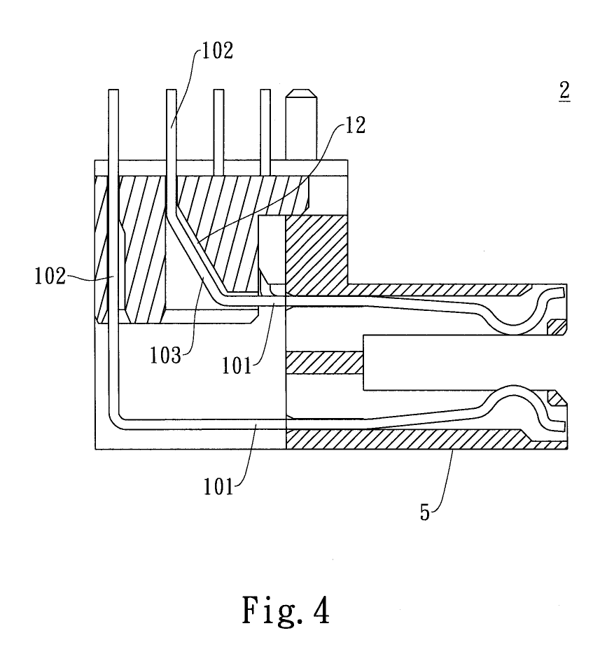

Referring to FIG. 2B which should be read in conjunction with FIG. 2A, the insulating body 5 has two Slimline SATA-style ports 10. The two Slimline SATA-style ports 10 are L-shaped and are arranged side by side. The plurality of terminal grooves 11 corresponding in position to the conductive terminal sets is disposed on the insulating body 5 and the back cover 4. The conductive terminal sets 6, 7, 8, 9 each have a horizontal portion 101 and a vertical portion 102. A portion of conductive terminals of the first conductive terminal set 6 has a inclined portion 103 (see FIG. 4). The inclined portion 103 is between the horizontal portion 101 and the vertical portion 102. The included angle between the inclined portion 103 and the horizontal portion 101 and the included angle between the inclined portion 103 and the vertical portion 102 are obtuse angles (again see FIG. 4). The horizontal portions 101 of the conductive terminal sets 6, 7, 8, 9 are received in the terminal grooves 11 of the insulating body 5. The vertical portions 102 of the conductive terminal sets 6, 7, 8, 9 penetrate a plurality of terminal sets 11 (terminal grooves 11) of the back cover 4. Hence, the back cover 4 and the insulating body 5 can be coupled together, as shown in FIG. 2B.

Referring to FIG. 3, the first conductive terminal set 6 and the second conductive terminal set 7 of the socket connector 2 according to the invention is shown. The first conductive terminal set 6, the second conductive terminal set 7, and the fourth conductive terminal set 9 function as pins for transmitting PCIe signals, respectively, with a transverse distance of 0.8 mm between conductive terminals of the first conductive terminal set 6, a transverse distance of 0.8 mm between conductive terminals of the second conductive terminal set 7, a longitudinal distance of 1.2 mm between the first conductive terminal set 6 and the second conductive terminal set 7, and a transverse distance of 1 mm between conductive terminals of the fourth conductive terminal set 9. The third conductive terminal set 8 and the fourth conductive terminal set 9 transmit SATA signals, with a transverse distance of 1.27 mm between conductive terminals of the third conductive terminal set 8 and a transverse distance of 1 mm between conductive terminals of the fourth conductive terminal set 9.

In the shown embodiment of FIGS. 2A and 3, the first conductive terminal set 6 has 11 pins, the second conductive terminal set 7 has seven pins, the third conductive terminal set 8 has seven pins, and the fourth conductive terminal set 9 has six pins. The first conductive terminal set 6 and the third conductive terminal set 8 are one above the other. The second conductive terminal set 7 and the fourth conductive terminal set 9 are one above the other.

Referring to FIG. 4, the socket connector 2 according to the invention is shown, and the horizontal portions 101 of the first conductive terminal set 6 and the second conductive terminal set 7 are received in the plurality of terminal grooves 11 of the insulating body 5. The vertical portions 102 of the first conductive terminal set 6 and the second conductive terminal set 7 penetrate the plurality of terminal grooves 11 of the back cover 4, such that major portions of the vertical portions 102 are received in the plurality of terminal grooves 11 of the back cover 4. To fit the inclined portions 103, an oblique angle portion 12 is disposed at each of the terminal grooves 11 of the back cover 4, such that the plurality of terminal grooves 11 encloses the vertical portions 102 and the inclined portions 103 of the first conductive terminal set 6 when the first conductive terminal set 6 is coupled to the back cover 4, and as a result, there is satisfactory impedance matching between the impedance of the socket connector 2 of the invention and a system impedance of 85 Ohm of PCIe Gen. 2.

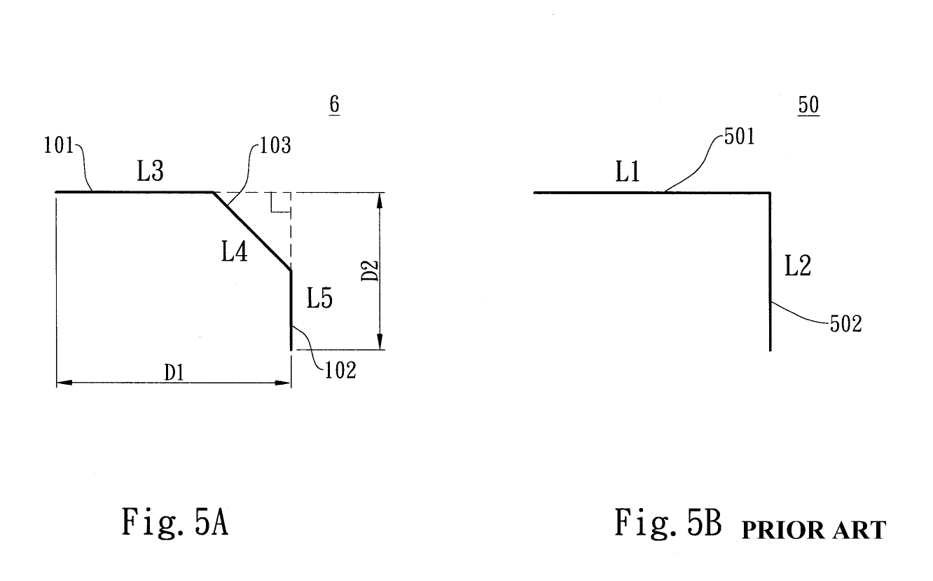

Referring to FIG. 5A, the first conductive terminal set 6 having the inclined portion 103 is shown. Considering that it is necessary to reduce the distance between terminals in order to meet the requirement of high-speed signals even though the height of the pins of the socket connector 2 is invariable, it is feasible that the goal of reducing the distance between terminals is achieved by the inclined portions 103 of the first conductive terminal set 6. As shown in FIG. 5A, the horizontal portion 101, the inclined portion 103, and the vertical portion 102 of the first conductive terminal set 6 of the invention are of lengths L3, L4 and L5, respectively, and thus the total length of the conductive terminal set 6 equals L3+L4+L5. By contrast, as shown in FIG. 5B, a known conductive terminal 50 has a horizontal portion 501 and a vertical portion 502. The lengths of the horizontal portion 501 and the vertical portion 502 are denoted with L1 and L2, respectively. Hence, the total length of the conductive terminal 50 equals L1+L2. Given L1=D1 and L2=D2, the inequality L3+L4+L5<L1+L2 is always true, because, in mathematics, the triangle inequality states that for any triangle, the sum of the lengths of any two sides must be greater than the length of the remaining side. Hence, the inclined portions 103 of the invention reduce the distances between terminals and thereby enhance the quality of high-speed signal transmission.

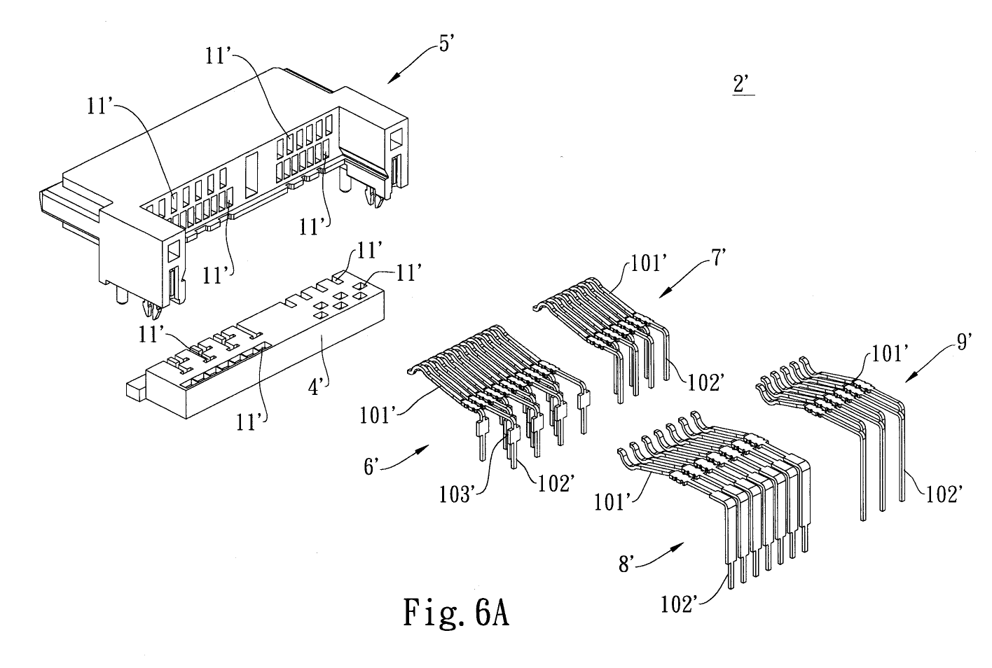

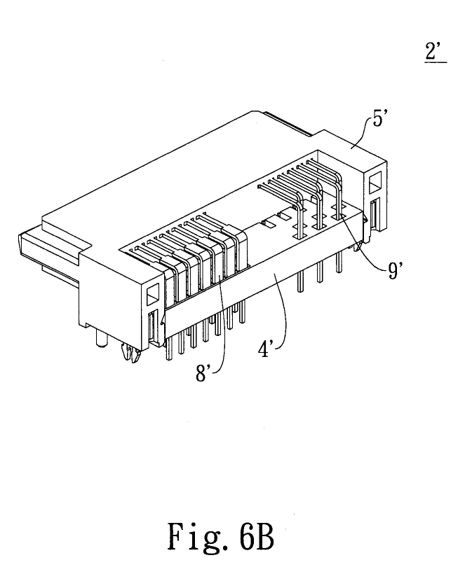

Referring to FIG. 6A and FIG. 6B, there are shown an exploded perspective view and an assembled view of another socket connector according to the invention, which is substantially the same as the aforementioned and described embodiment in FIGS. 2-5A, but is different from the second embodiment in two aspects. First, a first conductive terminal set 6′ in the shown embodiment only has a horizontal portion 101′ and a vertical portion 102′. Second, the terminals of the first conductive terminal set 6′ are shorter than the terminals of the first conductive terminal set 6 in the second embodiment. Hence, the height of the terminals in the shown embodiment of FIGS. 6A and 6B meets the high-frequency requirement and enhances the quality of high-speed signal transmission.

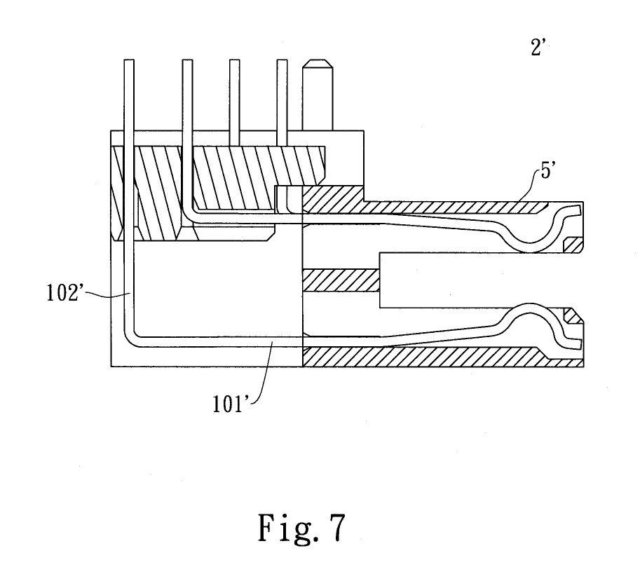

Referring to FIG. 7, there is shown a side cross-sectional view of the socket connector shown in FIGS. 6A and 6B, wherein the horizontal portions 101′ of the first conductive terminal set 6′ and a second conductive terminal set 7′ are received in a plurality of terminal grooves 11′ of an insulating body 5′, and the vertical portions 102′ of the first conductive terminal set 6′ and the second conductive terminal set 7′ penetrate the plurality of terminal grooves 11′ of a back cover 4′, such that major portions of the vertical portions 102′ are received in the plurality of terminal grooves 11′ of the back cover 4′, and the plurality of terminal grooves 11′ encloses the vertical portion 102′ and a inclined portion 103′. As a result, there is satisfactory impedance matching between the impedance of a socket connector 2′ of the invention and a system impedance of 85 Ohm of PCIe Gen. 2.

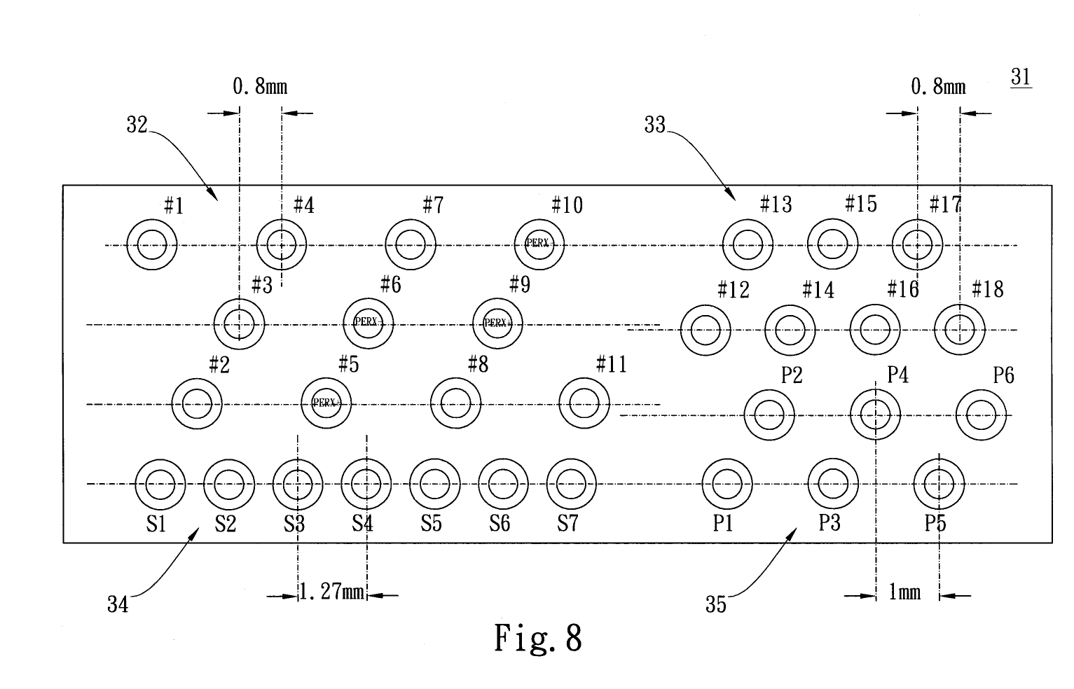

Referring to FIG. 8, there is shown a schematic view of a circuit board operating in conjunction with and connected to the first conductive terminal set 6 through the fourth conductive terminal set 9 of the socket connector 2 according to the invention. To facilitate description, FIG. 8 shows only a schematic bottom view of the circuit board. A first contact point set 32, a second contact point set 33, a third contact point set 34, and a fourth contact point set 35, which correspond in position to the first conductive terminal set 6 through the fourth conductive terminal set 9, respectively, are disposed on the circuit board. The first contact point set 32 has 11 contact points and corresponds in position to the first conductive terminal set 6 of the socket connector 2. The first contact point set 32 features a transverse distance of 0.8 mm and a longitudinal distance of 1.2 mm. The second contact point set 33 has seven contact points and corresponds in position to the second conductive terminal set 7 of the socket connector 2. The second contact point set 33 features a distance of 0.8 mm. The third contact point set 34 has seven contact points and corresponds in position to the third conductive terminal set 8 of the socket connector 2. The third contact point set 34 features a distance of 1.27 mm (contact point S3 and contact point S4 as shown in the diagram). The fourth contact point set 35 has six contact points and corresponds in position to the fourth conductive terminal set 9 of the socket connector 2. The fourth contact point set 35 features a distance of 1mm (contact point P4 and contact point P5 as shown in the diagram).

In shown embodiment, the first conductive terminal set 6 has pins denoted with reference numerals 1 through 11, with reference numerals 1, 4, 7, 8, 11 denoting ground pins, reference numerals 2, 3 denoting reference clock differential signal pair pins, reference numerals 5, 6 denoting data line sending-end differential signal pair pins, and reference numerals 9, 10 denoting data line receiving-end differential signal pair pins. The pins denoted with reference numerals 1 through 11 are high-speed signal transmission pins and are arranged in three alternate rows. The pins denoted with reference numerals 1, 4, 7, 10 are positioned at the row farthest from the third conductive terminal set. The pins denoted with reference numerals 2, 5, 8, 11 are positioned at the row nearest to the third conductive terminal set. The pins denoted by reference numerals 2, 5, 8, 11 alternate with the third conductive terminal set and the pins denoted by reference numerals 1, 4, 7, 10. The pins with the reference numerals 3, 6, 9 are positioned between the pins with reference numerals 1, 4, 7, 10 and the pins with reference numerals 2, 5, 8, 11, and alternate with the pins with reference numerals 1, 4, 7, 10 and the pins with reference numerals 2, 5, 8, 11.

The second conductive terminal set 7 has pins denoted with reference numerals 12 through 18. Reference numeral 12 denotes a 5V power pin which functions as an auxiliary power pin. Reference numeral 13 denotes a reference clock required signal pin. Reference numeral 14 denotes a reactivated signal linking pin. Reference numeral 15 denotes a basic reset pin. Reference numeral 16 denotes a system management bus data pin. Reference numeral 17 denotes a system management bus clock pin. Reference numeral 18 denotes a hot swap detecting pin. Reference numerals 12 through 18 denote low-speed signal transmission pins and power transmission pins. The pins denoted with reference numerals 12 through 18 are arranged in two alternate rows. The pins denoted with reference numerals 13, 15, 17 are arranged in the row farthest from the fourth conductive terminal set. The pins denoted with reference numerals 12, 14, 16, 18 are arranged in the row nearest to the fourth conductive terminal set. The pins denoted by reference numerals 12, 14, 16, 18 alternate with the pins denoted by reference numerals 13, 15, 17.

The third conductive terminal set 8 having pins S1˜S7 is disposed below the first conductive terminal set 6. The fourth conductive terminal set 9 having pins P1˜P6 is disposed below the second conductive terminal set 7. With the power pins being denoted with P2 and P3, respectively, the pin included in the plurality of conductive terminal sets and positioned farthest from the power signal terminal set is a ground pin (the pin denoted with reference numeral 1 and included in the first conductive terminal set 6), but the remaining pins are well known by persons skilled in the art and thus are not described in detail herein for the sake of brevity.

The power signal terminal set (the fourth conductive terminal set 9) is arranged in a way in conformity with the power transmission requirements set forth in the SATA protocol and is, together with the low-speed signal terminal set (the second conductive terminal set 7), disposed inside the terminal grooves 11 on two opposing sidewalls inside the insulating body 5 and in two alternate rows. The high-speed signal terminal set (the first conductive terminal set 6) is disposed inside the terminal grooves 11 on a sidewall inside the insulating body 5 and in three alternate rows, wherein the sidewall is not opposite to the sidewalls of the power signal terminal set.

The pins for transmitting PCIe signals, as disclosed in the invention, include the pins of the first conductive terminal set 6 and the second conductive terminal set 7 as well as the power pins of original SATA signal pins denoted with reference numerals P2, P3.

Regarding the two ground signal pins (denoted with reference numerals 7, 8) and two pairs of differential pair signal pins (denoted with reference numerals 5, 6, 9, 10) of the first conductive terminal set 6 of the invention, the differential pair signal pins with reference numerals 5, 6 are connected to contact point PETX− and contact point PETX+ on the circuit board, while the differential pair signal pins with reference numerals 9, 10 are connected to contact point PERX and contact point PERX−, such that two ground contact points disposed between contact point PETX and contact point PERX are connected to two ground signal pins (denoted with reference numerals 7, 8) of the first conductive terminal set 6 for reducing noise interference of the two pairs of differential pair signal proximal ends.

Referring to FIG. 9A through FIG. 9D, the invention further provides a plug connector 1 disposed on an external data input device (not shown). The plug connector 1 includes an insulating body 16, a plurality of conductive terminal sets, and a back cover 3. The plurality of conductive terminal sets are of two types, namely signal terminal set and power terminal set. There are three signal terminal sets of the plug connector 1, namely the fifth conductive terminal set 17, the sixth conductive terminal set 18, and the seventh conductive terminal set 19. The power terminal set is the eighth conductive terminal set 20. The insulating body 16 has a Slimline SATA-style slot 21, two L-shaped tongue members 22, and the plurality of terminal grooves 23 for engagement with the plurality of conductive terminal sets. The fifth conductive terminal set 17 is a high-speed signal terminal set. The sixth conductive terminal set 18 is a low-speed signal terminal set. The seventh conductive terminal set 19 is a SATA signal terminal set.

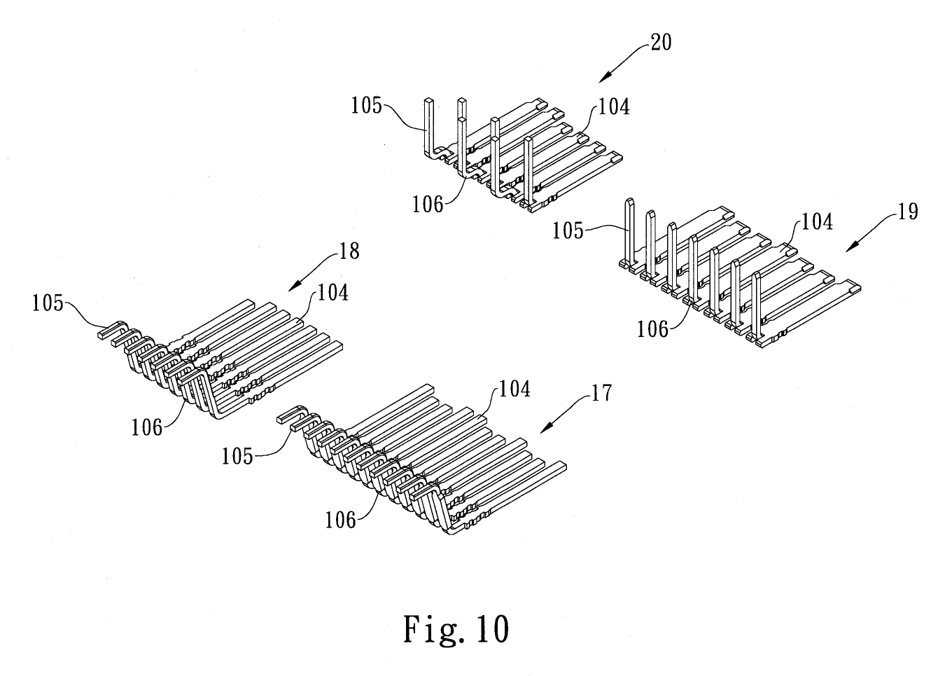

Referring to FIG. 10, there is shown an exploded perspective view of the conductive terminal sets 17, 18, 19, 20 in an embodiment of the invention. The conductive terminal sets 17, 18, 19, 20 each have a contact portion 104, a solder portion 105, and a bend portion 106 connected between the contact portion 104 and the solder portion 105. The contact portions 104 of the conductive terminal sets 17, 18 are received in the plurality of terminal grooves 23 on the upper side surface of the L-shaped tongue members 22. The contact portions 104 of the conductive terminal sets 19, 20 are received in the plurality of terminal grooves 23 on the lower side surface of the L-shaped tongue members 22. Hence, the signal terminal sets (the fifth conductive terminal set 17, the sixth conductive terminal set 18, and the seventh conductive terminal set 19) and the power terminal set (the eighth conductive terminal set 20) are disposed on two different sides of the L-shaped tongue members 22, respectively. The fifth conductive terminal set (high-speed signal terminal set) is disposed in a plurality of terminal grooves on the upper side surface of one said L-shaped tongue member. The seventh conductive terminal set (SATA signal terminal set) is disposed in the plurality of terminal grooves 23 on the lower side surface of the L-shaped tongue member 22 different from the high-speed signal terminal set. The sixth conductive terminal set (low-speed signal terminal set) is disposed in the plurality of terminal grooves on the upper side surface of the other said L-shaped tongue member. The eighth conductive terminal set (the power terminal set) is disposed in the plurality of terminal grooves 23 on the lower side surface of the L-shaped tongue member 22 different from the low-speed signal terminal set. The power terminal set is arranged in a way in conformity with the power transmission requirements set forth in the SATA protocol. The signal terminal set is arranged in a way in conformity with the signal transmission requirements set forth in the PCIe protocol. The back cover 3 is connected to the insulating body 16. The back cover 3 has a plurality of terminal grooves 24 for receiving and enclosing the bend portions 106 of the conductive terminal sets 17, 18, 19, 20.

Referring to FIG. 9 and FIG. 10, in the shown embodiment, the fifth conductive terminal set 17, the sixth conductive terminal set 18, and the eighth conductive terminal set 20 are pins for transmitting PCIe signals. Conductive terminals among the fifth conductive terminal set 17 and the sixth conductive terminal set 18 are spaced apart from each other by a transverse distance of 0.8 mm. Conductive terminals of the eighth conductive terminal set 20 are spaced apart from each other by a transverse distance of 1 mm. The purpose of the seventh conductive terminal set 19 and the eighth conductive terminal set 20 is to transmit SATA signals. Conductive terminals of the seventh conductive terminal set 19 are spaced apart from each other by a transverse distance of 1.27 mm. Conductive terminals of the eighth conductive terminal set 20 are spaced apart from each other by a transverse distance of 1 mm.

In the shown embodiment, the fifth conductive terminal set 17 has 11 pins. The 11 pins of the fifth conductive terminal set 17 are high-speed signal transmission pins. The 11 pins of the fifth conductive terminal set 17 have the same title and function as the pins of the first conductive terminal set 6 do, and thus related details are not described repeatedly for the sake of brevity. The sixth conductive terminal set 18 has seven pins. The seven pins of the sixth conductive terminal set 18 are low-speed signal transmission pins. The seven pins of the sixth conductive terminal set 18 have the same title and function as the pins of the second conductive terminal set 7 do, and thus related details are not described repeatedly for the sake of brevity. The seventh conductive terminal set 19 has seven pins. The seven pins of the seventh conductive terminal set 19 are SATA signal transmission pins. The eighth conductive terminal set 20 has six pins. The six pins of the eighth conductive terminal set 20 are power signal transmission pins. The six pins of the eighth conductive terminal set 20 have the same title and function as the pins of the fourth conductive terminal set 9 do, and thus related details are not described repeatedly for the sake of brevity. The farthest pin in the plurality of terminal sets (conductive terminal sets) from the power signal terminal set is a ground pin.

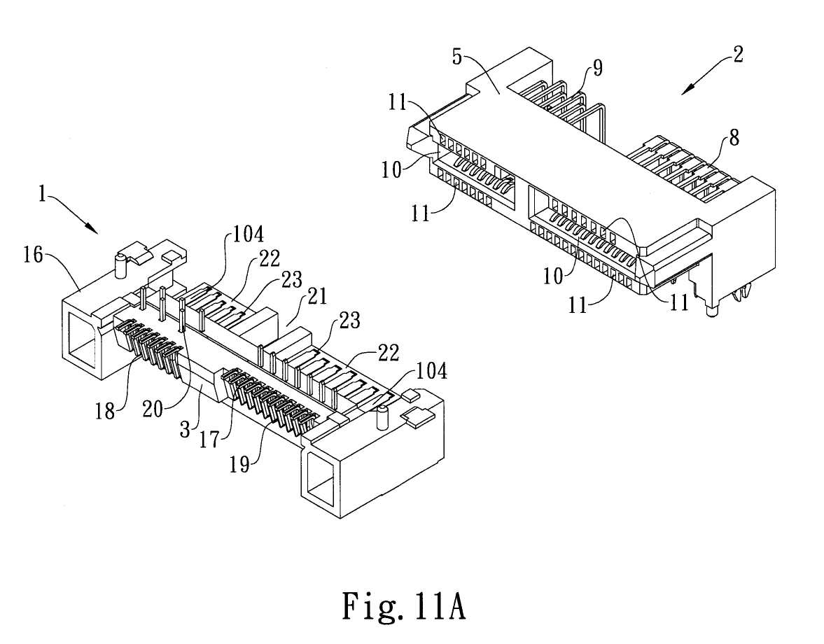

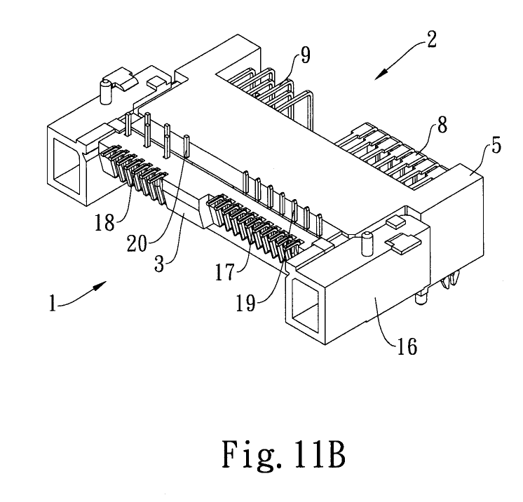

Referring to FIG. 11A and FIG. 11B, there are shown an exploded view and an assembled view of the socket connector and the plug connector connected to each other according to the third embodiment of the invention. When the plug connector 1 and the socket connector 2 are engaged with each other, the front end of the socket connector 2 is received in the Slimline SATA-style slot 21 of the plug connector 1, and the L-shaped tongue members 22 are received in the Slimline SATA-style ports 10, such that the conductive terminal sets 17, 18, 19, 20 of the plug connector 1 are coupled to the conductive terminal sets 6, 7, 8, 9 of the socket connector 2, respectively, and the contact portions 104 are electrically connected to the horizontal portions 101.

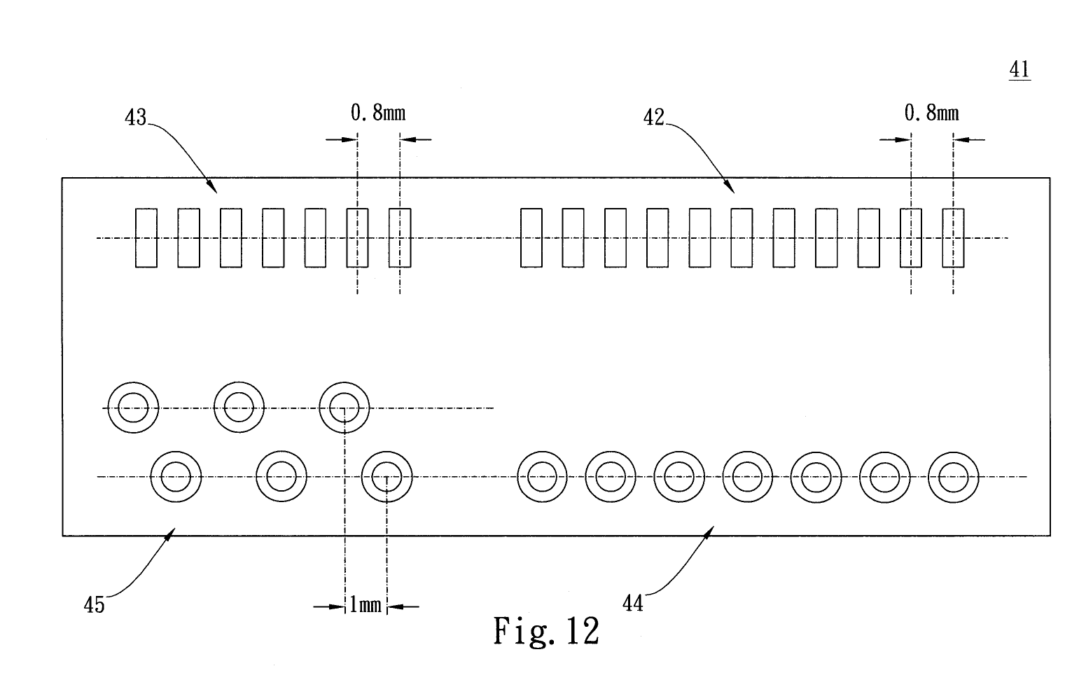

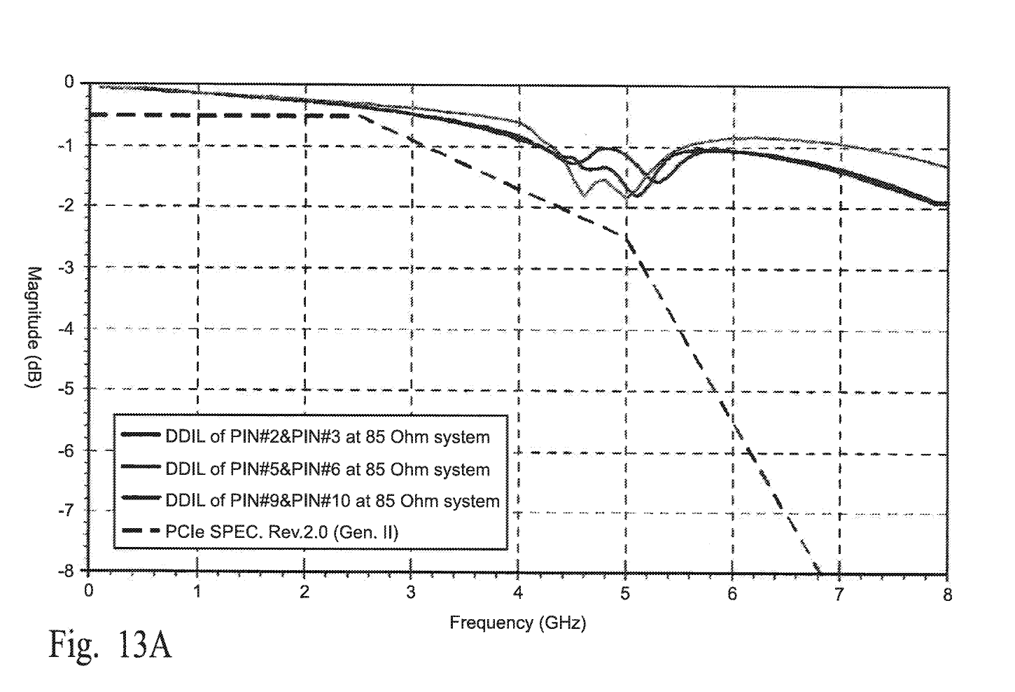

Referring to FIG. 12, a circuit board operating in conjunction with and connected to the fifth conductive terminal set through the eighth conductive terminal set of the plug connector 1 according the invention is shown. To facilitate description, the drawings only show a schematic bottom view of the circuit board. A fifth contact point set 42 and a sixth contact point set 43, which correspond in position to the fifth conductive terminal set 17 (high-speed signal transmission pins) and the sixth conductive terminal set 18 (low-speed signal transmission pins), respectively, are mounted on the circuit board by Surface Mount Technology (SMT). The fifth contact point set 42 has 11 contact points, corresponds in position to the fifth conductive terminal set 17 of the plug connector 1, and has a transverse distance of 0.8 mm. The sixth contact point set 43 has seven contact points, corresponds in position to the sixth conductive terminal set 18 of the plug connector 1, and has a transverse distance of 0.8 mm. The plurality of terminal sets (conductive terminal sets) each have a contact portion 104 and a solder portion 105. The solder portions 105 of the high-speed and low-speed signal transmission pins are secured to the circuit board by SMT. A seventh contact point set 44 and an eighth contact point set 45, which correspond in position to the seventh conductive terminal set 19 and the eighth conductive terminal set 20, respectively, are disposed on the circuit board by Pin Through Hole (PTH) technology. The solder portions 105 of the seventh conductive terminal set 19 and the eighth conductive terminal set 20 are secured to the circuit board by PTH technology. Given the aforesaid hybrid footprint (SMT & Through Hole) on the plug connector 1, the fifth conductive terminal set 17 and the sixth conductive terminal set 18 are mounted by SMT, so as to reduce intra-pair skew and thereby meet a connector high-frequency characteristic requirement set forth in the PCIe Gen. 2 protocol.

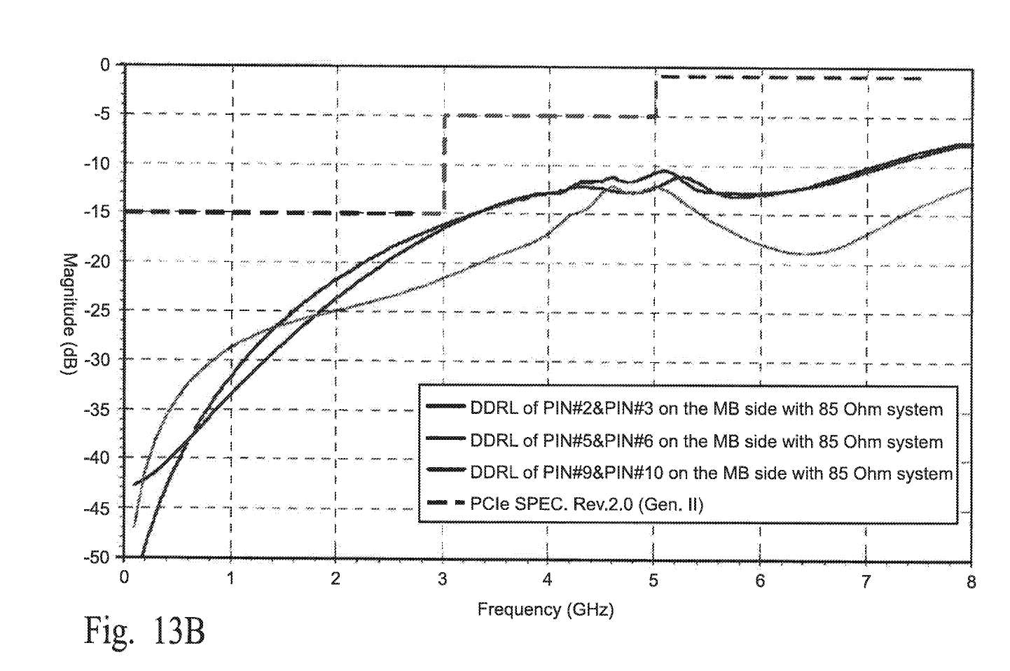

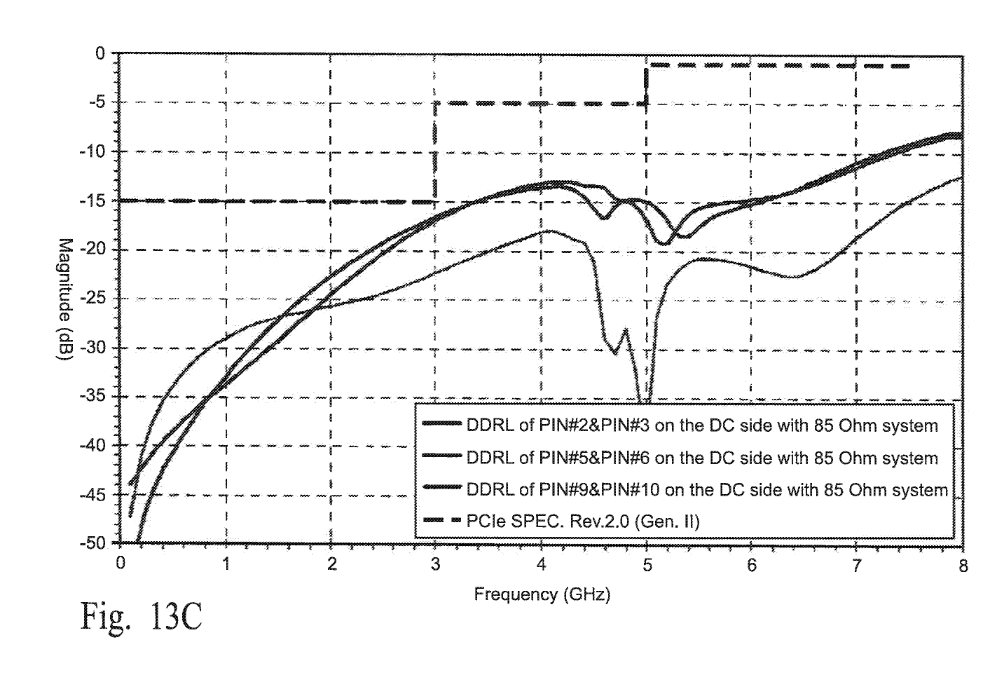

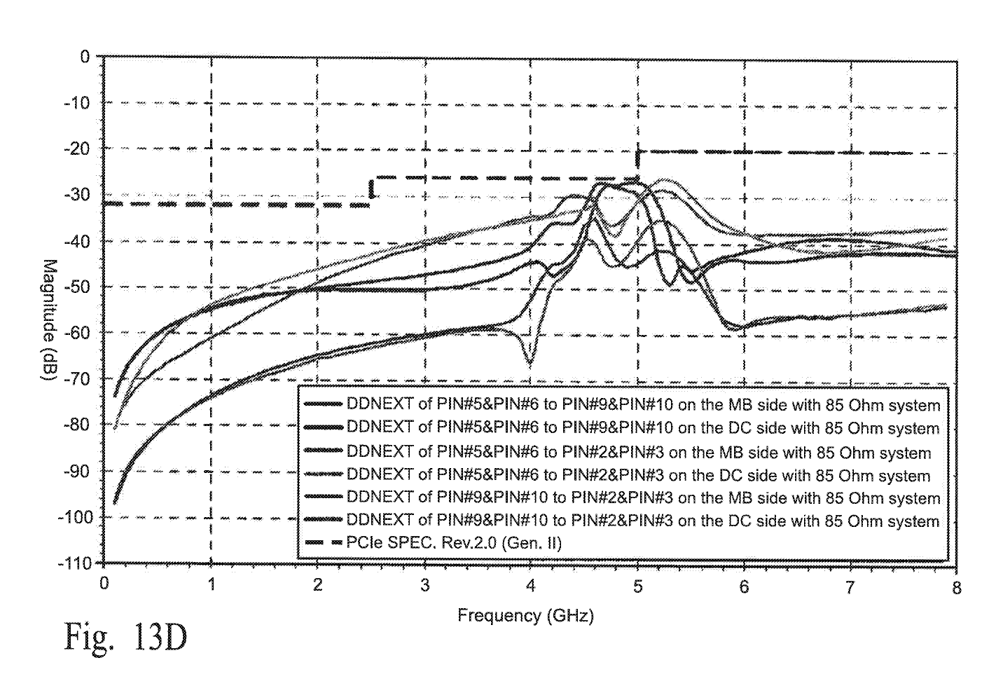

The socket connector and the plug connector of the invention are based on the original structure of a Slimline SATA connector and additionally equipped with terminal sets (conductive terminal sets) for transmitting PCIe signals. Hence, the socket connector and the plug connector of the invention comply with both the SATA protocol and the PCIe Gen 2 protocol. By reducing the longitudinal distance of the first conductive terminal set and the second conductive terminal set of the socket connector of the invention to 1.2 mm, setting the transverse distance of the fifth conductive terminal set and the sixth conductive terminal set of the plug connector of the invention to 0.8 mm, and applying a hybrid footprint (SMT & Through Hole) to the plug connector, it is feasible to reduce intra-pair skew. By providing the socket connector and the plug connector with a back cover for enclosing the vertical portions of most of the conductive terminal sets, it is feasible to ensure that there is satisfactory impedance matching between the differential impedance of the connectors and a system differential impedance of 85 Ohm of PCIe Gen. 2, cause the resonance frequency to move toward a higher frequency, and meet the signal attenuation requirement set forth in the PCIe Gen. 2 protocol, as shown in FIG. 13, such that the socket connector and the plug connector of the invention not only comply with the SATA protocol and the PCIe Gen. 2 protocol but also achieve optimization.

There are several advantages of the connector according to the invention.

For instance, due to its appearance and ports, the Slimline SATA connector is conducive to transmitting PCIe signals and suitable for use with other devices in conformity with the PCIe Gen. 2 protocol.

The connector according to the invention is equipped with a plurality of terminal sets (conductive terminal sets) for transmitting SATA signals. Power signal transmission pins of the plurality of terminal sets (conductive terminal sets) for transmitting PCIe signals can solely operate in conjunction with the plurality of terminal sets (conductive terminal sets) for transmitting SATA signals, so as to be suitable for use with other devices in conformity with the SATA protocol.

Despite spatial limitations of the connector in terms of width and height, the total length of the conductive terminal sets can be reduced so as to enhance the quality of high-speed signal transmission. The inclined portion according to the invention is disposed between the horizontal portion and the vertical portion of a specific one of the conductive terminal sets of the socket connector of the invention serves to reduce the total length of the conductive terminal sets.

The invention is disclosed above by preferred embodiments. However, persons skilled in the art should understand that the preferred embodiments are illustrative of the invention only, but should not be interpreted as restrictive of the scope of the invention. Hence, persons skilled in the art clearly understand that various modifications and changes can be made to the aforesaid embodiments, provided the modifications and changes do not depart from the scope and spirit of the invention.

1. A connector comprising:
a first plurality of conductive terminals having:
(a) a first high-speed signal terminal,
(b) a first low-speed signal terminal, and
(c) a first power signal terminal;
a first insulating body having:
(a) a port,
(b) two inner, oppositely disposed, sidewalls, and
(c) a first plurality of terminal grooves disposed in rows and receiving the first plurality of conductive terminals with the first power signal terminal and the first low-speed signal terminal positioned:
(1) along the two oppositely disposed inner sidewalls, and
(2) in terminal grooves in two alternate rows of the terminal grooves;
a second plurality of conductive terminals having:
(a) a second low-speed terminal, and
(b) a second power signal terminal; and
a second insulating body having:
(a) a slot,
(b) an L-shaped tongue member, and
(c) a plurality of terminal grooves receiving the second plurality of conductive terminals with the second power signal terminal and the second low-speed terminal positioned on different sides of the L-shaped tongue member.

2. The connector according to claim 1, wherein the first high-speed signal terminal is disposed in a terminal groove at a sidewall opposite the groove in which the first power signal terminal is disposed.

3. The connector according to claim 2, wherein the first low-speed signal terminal includes an auxiliary power pin.

4. A socket connector, comprising:
an insulating body having a Slimline SATA-style port with a plurality of terminal grooves disposed on an upper side and a lower side inside the Slimline SATA-style port; and
a plurality of conductive terminal sets including signal terminals and a power terminal, wherein the signal terminals and the power terminal are positioned on two different sides of the plurality of terminal grooves, respectively, and each conductive terminal has a horizontal portion and a vertical portion, the horizontal portion of each conductive terminal corresponding in position to and being received in one of a plurality of terminal grooves of the insulating body, respectively;
wherein the signal terminals include a first conductive terminal set, a second conductive terminal set, and a third conductive terminal set, and the power terminal is a fourth conductive terminal set, the first conductive terminal set positioned above the third conductive terminal set and the second conductive terminal set positioned above the fourth conductive terminal set.

5. The socket connector according to claim 4, wherein the first conductive terminal set includes eleven pins spaced apart from each other by a distance of 0.8 mm, the second conductive terminal set includes seven pins spaced apart from each other by a distance of 0.8 mm, the fourth conductive terminal set includes six pins spaced apart from each other by a distance of 1 mm.

6. The socket connector according to claim 4, wherein the first conductive terminal set, the second conductive terminal set, and the fourth conductive terminal set are for transmitting PCIe signals.

7. The socket connector according to claim 6, wherein the eleven pins of the first conductive terminal set are arranged in three alternate rows and includes five ground pins, two clock differential signal pair pins, two data line sending-end differential signal pair pins, and two data line receiving-end differential signal pair pins.

8. The socket connector according to claim 7, wherein the eleven pins of the first conductive terminal set are high-speed signal transmission pins.

9. The socket connector according to claim 7, wherein the seven pins of the second conductive terminal set are arranged in two alternate rows and include a 5V power pin, a reference clock required signal pin, a reactivated signal linking pin, a basic reset pin, a system management bus data pin, a system management bus clock pin, and a hot swap detecting pin.

10. The socket connector according to claim 9, wherein the seven pins of the second conductive terminal set include low-speed signal transmission pins and power transmission pins.

11. The socket connector according to claim 4, further comprising a back cover having a plurality of terminal grooves and connected to the insulating body, the plurality of terminal grooves of the back cover receiving and enclosing the vertical portions of the plurality of conductive terminal sets.

12. The socket connector according to claim 11, wherein one of the signal terminals has an inclined portion disposed between the horizontal portion and the vertical portion, such that an included angle between the inclined portion and the horizontal portion and an included angle between the inclined portion and the vertical portion each are obtuse angles.

13. The socket connector according to claim 12, wherein an oblique angle portion corresponding in position to the inclined portion of the a conductive terminal of the first conductive terminal set is disposed at the back cover.

14. A plug connector, comprising:
an insulating body having a Slimline SATA-style slot, a L-shaped tongue member, and a plurality of terminal grooves; and
a plurality of conductive terminal sets received by the plurality of terminal grooves that includes seven signal terminal sets and a power terminal;
wherein the signal terminal sets and the power terminal are disposed on two different sides of the L-shaped tongue member.

15. The plug connector according to claim 14, wherein a first of the conductive terminal sets includes eleven pins spaced apart from each other by a distance of 0.8 mm, a second of the conductive terminal sets includes seven pins spaced apart from each other by a distance of 0.8 mm, and a third of the conductive terminal sets includes six pins spaced apart from each other by a distance of 1 mm.

16. The plug connector according to claim 15, wherein the first conductive terminal set, the second conductive terminal set, and the third conductive terminal set transmit PCIe signals.

17. The plug connector according to claim 16, wherein the each of the conductive terminals in the plurality of conductive terminal sets includes a contact portion and a solder portion.

18. The plug connector according to claim 17, wherein the solder portions in the first conductive terminal set and the second conductive terminal set are secured to a circuit board by Surface Mount Technology (SMT).

19. The plug connector according to claim 18, wherein the solder portion in the remaining conductive terminal sets set are secured to the circuit board by Pin Through Hole (PTH) technology.
